(19) United States
(12) Patent Application Publication
(10) Pub. No.: US 2011/0295596 A1
(43) Pub. Date: Dec. 1, 2011

(54) DIGITAL VOICE RECORDING DEVICE WITH MARKING FUNCTION AND METHOD THEREOF

(75) Inventors: SHU-CHUAN HUNG, Tu-Cheng (TW); CHEN-HUANG FAN, Tu-Cheng (TW)

(73) Assignee: HON HAI PRECISION INDUSTRY CO., LTD., Tu-Cheng (TW)

(21) Appl. No.: 12/838,483

(22) Filed: Jul. 18, 2010

(30) Foreign Application Priority Data
May 31, 2010 (CN) 201010186890.1

(51) Int. Cl. G10L 19/00

(52) U.S. Cl. 704/201; 704/E19.001

(57) ABSTRACT

A digital voice recording device includes a storage unit, a display unit, and a processing unit. The processing unit includes a recording module, a storing module, a marking module, and a playing module. The recording module converts audio into digital signals, and records the digital signals into an audio file. Each audio file is associated with a document including textual content of the audio file. The storing module stores the audio file and the document. The display module displays the document. The marking module creates a plurality of flags for the audio file. Each flag is associated with a time point in the audio file, and is assigned an identifier. The playing module identifies an identifier of a flag to acquire a time point in response to a user input, and begin playing the audio file from the acquired time point.

### BACKGROUND

1. Technical Field

The present disclosure relates to digital voice recording devices and, particularly, to a digital voice recording device having a marking function and a method thereof.

2. Description of Related Art

A digital voice recorder converts audio analog signals, such as human voices, into digital signals, records the digital signals in an audio file, and stores the audio file in a storage unit. When attempting to listen to a desired section of the audio file, a user may have to drag a slide bar to search for the desired section, which can be time-consuming and inconvenient.

Therefore, what is needed is a digital voice recording device to overcome the described shortcoming

### BRIEF DESCRIPTION OF THE DRAWINGS

FIG. 1 is a block diagram of a hardware infrastructure of a digital voice recording device with a marking function in accordance with an exemplary embodiment.

FIG. 2 is a schematic diagram showing an operation window of the digital voice recording device of FIG. 1.

FIG. 3 is similar to FIG. 2, but showing that a plurality of flags is created by the digital voice recording device of FIG. 1.

FIG. 4 is a flowchart of a marking method implemented by the digital voice recording device of FIG. 1 in accordance with an exemplary embodiment.

### DETAILED DESCRIPTION

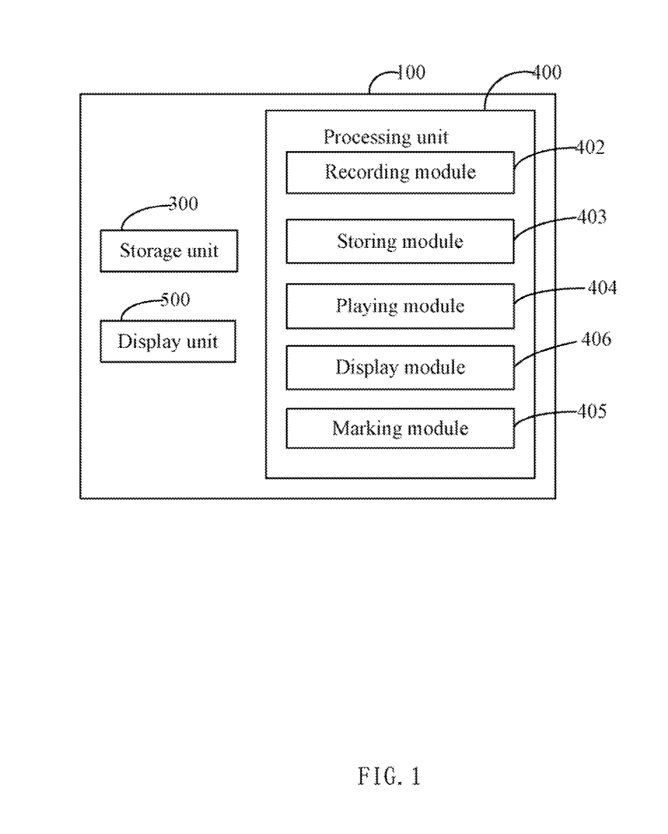

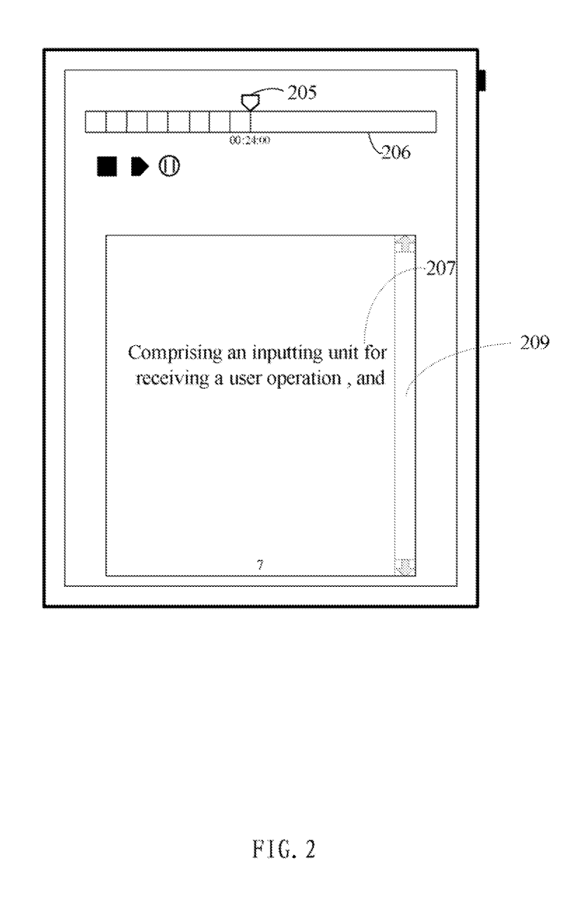

Referring to FIGS. 1-2, a digital voice recording device 100 includes a storage unit 300, a processing unit 400 and a display unit 500. The display unit 500 can be a touching sensitive screen and can serve as an input device.

The processing unit 400 includes a recording module 402, a storing module 403, a playing module 404, a marking module 405, and a display module 406.

The recording module 402 is configured for converting audio such as human voices into digital signals and recording the digital signals in an audio file in response to a user input from the display unit 500. Each audio file is associated with a document including textual content of the audio file. In the embodiment, the textual content of the document may be stories, notes, teaching materials, etc. For example, as shown in FIG. 2, a document 209 includes a textual content 207.

The storing module 403 is configured for storing the recorded audio file and the document associated with the audio file in the storage unit 300.

The display module 406 can be controlled to display a slide bar that can be dragged to select a particular point in an audio file on the display unit 500. The display module 406 can also be controlled to display a textual content associated with the audio file on the display unit 500. The display module 406 can further be controlled to display a progress bar when recording voice and playing an audio file. For example, as shown in FIG. 2, the display module 406 displays a slide bar 205 and a progress bar 206 on the display unit 500.

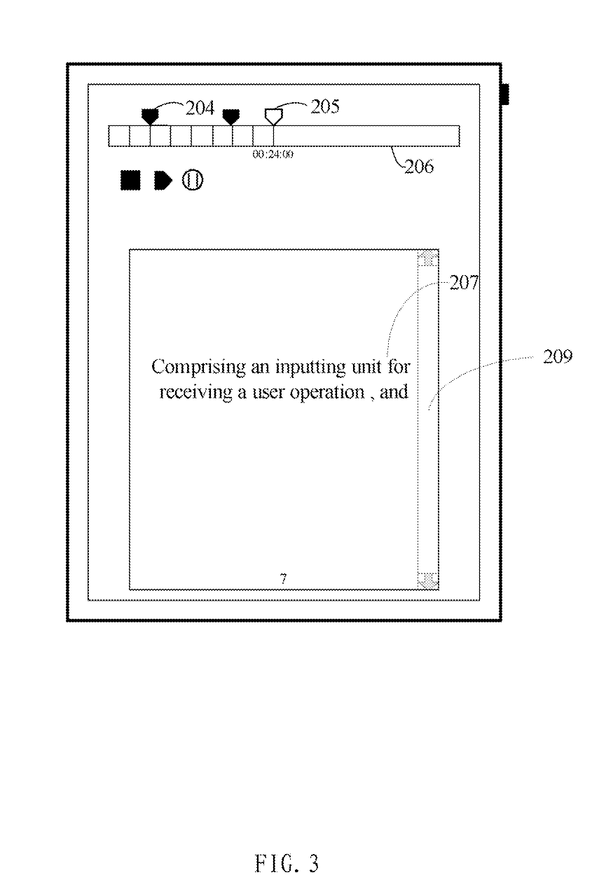

The marking module 405 is configured for creating a plurality of flags in response to a user input from the display unit 500. Each flag is associated with a time point in the audio file and a section of the textual content associated with the audio file, and is assigned an identifier. For example, as shown in FIG. 3, when a user is interested in a specific part of the audio file, he/she can touch the display unit 500 on a position on a progress bar corresponding to the specific part. A flag is thus created adjacent to the position, such as the flags 204.

The playing module 404 is configured for playing the audio file. Once the audio files start to play, the flags (if available) are displayed. If a position on the display unit 500 corresponding to one of the flags is touched, the playing module 404 identifies the identifier associated with the one of the flags, and starts to play the audio file from the time point corresponding to the one of the flags. The specific section of the textual content corresponding to the one of the flags is also displayed on the display unit 500. For example, as shown in FIG. 3, when a user touches one of the flags 204 on the display unit 500, the playing module 404 identifies the identifier of the touched flag to acquire a time point and plays the audio file from the acquired time point.

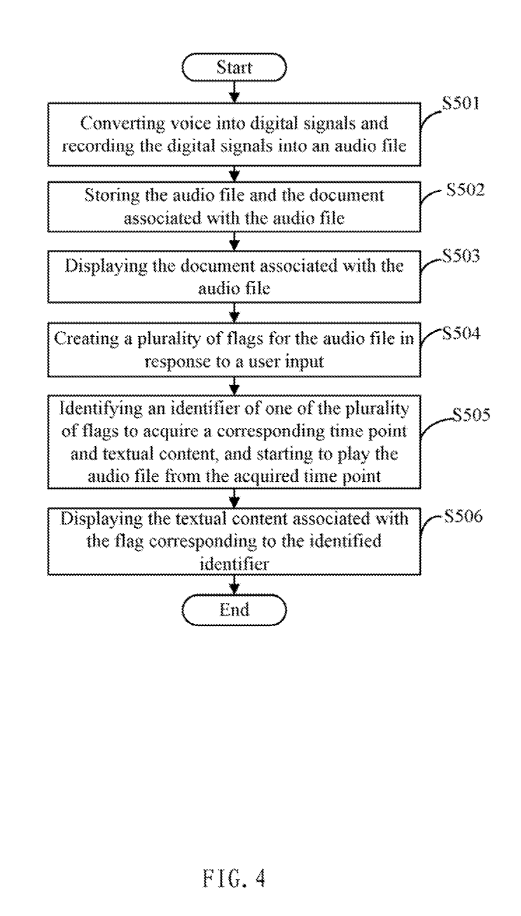

FIG. 4 is a flowchart of a marking method implemented by the digital voice recording device 100 of FIG. 1 in accordance with an exemplary embodiment.

In step S501, the recording module 402 converts voice into digital signal and records the digital signal in an audio file in response to a user input from the display unit 500.

In step S502, the storing module 403 stores the audio file and the document associated with the audio file in the storage unit 300.

In step S503, the display module 406 displays the textual content associated with the audio file on the display unit 500.

In step S504, the marking module 405 creates a plurality of flags in response to a user input from the display unit 500.

In step S505, when a position on the display unit 500 corresponding to one of the flags is touched, the playing module 404 identifies the identifier associated with the one of the flags, and starts to play the audio file from the time point corresponding to the one of the flags.

In step S506, the display module 406 further displays a specific textual content corresponding to one of the touched flags on the display unit 500.

Although the present disclosure has been specifically described on the basis of the embodiments thereof, the disclosure is not to be construed as being limited thereto. Various changes or modifications may be made to the embodiments without departing from the scope and spirit of the disclosure.

What is claimed is:

1. A digital voice recording device with a marking function, comprising:
a storage unit;
a display unit; and
a processing unit comprising:
a recording module for converting voice into digital signals, and recording the digital signals in an audio file in response to a user input, wherein each audio file is associated with a document comprising textual content of the audio file;
a storing module for storing the audio file and the document associated with the audio file in the storage unit;
a display module for displaying the textual content associated with the audio file on the display unit;
a marking module for creating a plurality of flags in response to a user input, wherein each flag is associated with a time point in the audio file and a section of the textual content, and is assigned an identifier; and
a playing module for identifying an identifier of one of the plurality of flags to acquire a corresponding time point in response to a user input, and starting to play the audio file from the acquired time point.

2. The digital voice recording device as described in claim 1, wherein the display unit is a touching sensitive screen, the recording module converts audio into digital signals, and records the digital signals in an audio file in response to a touching operation from the display unit, the marking module creates the plurality of flags in response to a touching operation from the display unit, and the playing module identifies an identifier of one of the plurality of flags to acquire a corresponding time point in response to a touching operation from the display unit, and starts to play the audio file from the acquired time point.

3. The digital voice recording device as described in claim 1, wherein the display module is further configured for displaying a slide bar which is to be dragged to select a particular point in the audio file on the display unit.

4. The digital voice recording device as described in claim 1, wherein the display module is further configured for displaying a progress bar when recording voice and playing an audio file.

5. The digital voice recording device as described in claim 4, wherein the marking module is further configured for creating the plurality of flags on the progress bar in response to a user input.

6. The digital voice recording device as described in claim 1, wherein the display module is further configured for displaying a section of the textual content corresponding to the one of the flags in response to a user input.

7. A method for creating a plurality of flags for an audio file which is associated with a document comprising textual content of the audio file; the method comprising:
displaying the document associated with the audio file;
creating a plurality of flags for the audio file in response to a user input, wherein each flag is associated with a time point of the audio file, and is assigned an identifier; and
identifying an identifier of one of the plurality of flags to acquire a corresponding time point in the audio file in response to a user input, and starting to play the audio file from the corresponding time point.

8. The method as described in claim 7, wherein each flag is further associated with a section of textual content, the method further comprising:
displaying a section of textual content corresponding one of the plurality of flags in response to a user input.

9. The method as described in claim 7, further comprising:
converting the audio into the digital signals, and recording the digital signals in an audio file in response to a touching operation;
creating a plurality of flags for the audio file in response to a touching operation, and
identifying an identifier of one of the plurality of flags to acquire a corresponding time point in the audio file in response to a touching operation.

10. The method as described in claim 7, further comprising:
displaying a slide bar which is to be dragged to select a particular point in the audio file.

11. The method as described in claim 7, further comprising:
displaying a progress bar when recording audio and playing the audio file.
